(19) United States
(12) Patent Application Publication
(10) Pub. No.: US 2014/0201527 A1
(43) Pub. Date: Jul. 17, 2014

(54) SYSTEMS AND METHODS FOR SECURE AND PRIVATE DELIVERY OF CONTENT

(71) Applicant: Zohar Krivorot, Hampstead (CA)

(72) Inventor: Zohar Krivorot, Hampstead (CA)

(21) Appl. No.: 13/786,969

(22) Filed: Mar. 6, 2013

Related U.S. Application Data
(60) Provisional application No. 61/753,778, filed on Jan. 17, 2013.

(51) Int. Cl. G06F 21/60

(52) U.S. Cl. CPC G06F 21/602
USPC 713/168

(57) ABSTRACT

The present solution provides a new tool for privately and securely delivering content from a send to a recipient. Additionally, the tool provides a system and method for ensuring the content is not seen by onlookers, retransmitted, or copied. The system described herein accomplishes the protection of content by several different means. For example, the system may never store unencrypted copies of content to a local device, such that content may not be viewed by a system other than the system described herein. Additionally, the system may overlay an obfuscating layer to the content when the content is displayed on a client device. Such an obfuscating layer prevents onlookers from unintentionally viewing the content. It may also prevent a recipient from capturing a screen shot or copying the content. Furthermore, the system may also set a number of expiring timers on the content. For example, a first expiration timer may automatically delete send content from a recipient device a set time after the content has been sent. A self-destruct expiring timer may delete the content a short time after a user begins to view the content.

### RELATED APPLICATION

This application claims the benefit of and priority to U.S. Provisional Application No. 61/753,778, entitled “Systems and Methods For Secure and Private Delivery of Content”, filed on Jan. 17, 2013, which is incorporated herein by reference in its entirety for all purposes.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### BACKGROUND OF THE DISCLOSURE

With the increased popularity of internet enabled mobile phones, the instant distribution of content is easier than ever. This content may include text messages, videos and pictures. Unfortunately, in this interconnected age, the recipient of a content item can duplicate, manipulate, or forward the content on to numerous people without the knowledge of the original sender.

### BRIEF SUMMARY OF THE DISCLOSURE

The present solution provides a new tool for privately and securely delivering content from a sender to a recipient. Additionally, the tool provides a system and method for ensuring the content is not seen by onlookers, retransmitted, or copied. The system described herein accomplishes the protection of content by several different means. For example, the system may never store unencrypted copies of content to a local device, such that content may not be viewed by a system other than the system described herein. Additionally, the system may overlay an obfuscating layer to the content when the content is displayed on a client device. Such an obfuscating layer prevents onlookers from unintentionally viewing the content. The system may also prevent a recipient from capturing a screen shot or copying the content. Furthermore, the system may also set a number of expiring timers on the content. For example, a first expiration timer may automatically delete send content from a recipient device a set time after the content has been sent. A self-destruct expiring timer may delete the content a short time after a user begins to view the content.

For example, in one implementation a user may use the system and methods described herein to safely and privately deliver content in the form of text, images, pictures or video from the user's smart phone to the smart phone of a friend. The content delivered between the cell phones may be a short message service (SMS) message and/or a multimedia messaging service (MMS) message, collectively and generally discussed herein as a text message. The text message may include text, image or video that the user does not wish to be viewed by unintended recipients and/or distributed beyond the friend. To further the example, the user may send a text message to a friend with a computer program as disclosed herein. The program may allow the user to securely send the text message to the friend without locally storing the message on the user's phone. After the user sends the message, the message may be securely stored in the cloud. The friend may view the message stored on the cloud server with the disclosed computer programming running on the friend's phone. By saving encrypted message to the cloud, local copies of the message are not created and may not be retransmitted. Additionally, when sending the message, the user may implement viewing restrictions when the friend views the message. These restrictions may include a restriction that obscures the content of the message such that only a portion of the content is revealed at any give time. The restrictions may also include placing an expiration on the message such that the message self-destructs and is deleted from the cloud at a given time. In some implementations, not only will the message self-destruction but between the time the message is received and the message self-destructs, the user can only view portions of the content in an obscured manner. These restrictions may ensure the message is not copied, retransmitted, viewed by onlookers, or any combination thereof.

In some aspects, the present solution is directed to a method for providing a secure and private message for limited viewing. The method includes receiving, by a message viewing application executing on a device, a notification of an encrypted message stored on a server and retrieving, by the message viewing application, the encrypted message from the server. The method further includes decrypting, by the message viewing application, the encrypted message to a message in memory of the device. The message has a predetermined expiration time comprising a predetermined time (such as a number of minutes or seconds) from receipt of the message upon which the message is automatically deleted for viewing via the message viewing application. The method also includes providing, by the message viewing application, the message from memory, for obscured viewing, only for the predetermined time between receipt of the message and automatic deletion of the message by the message viewing application upon expiration of the predetermined expiration time for the message and providing, by the message viewing application, an obscure viewer that displays an unobscured view of a portion of the message at a time while maintaining remaining portions of the message obscured.

In some embodiments, the method includes receiving, by the server, a request from a second message viewing application, executing on a second device, to send the message to a user of the message viewing application. The server receives the message from the second message viewing application securely and stores the message as the encrypted message on the server. In some embodiments, the method includes receiving, by the server, the predetermined expiration time for the message specified from the second message viewing application.

In some embodiments, the method includes storing, by the message viewing application, the encrypted message to storage of the device. The method may further include decrypting, by the message viewing application, the stored encrypted message and storing the message from the decryption only in the memory of the device.

In some embodiments, the method includes receiving, by the message viewing application, a selection by a user to view the message within the message viewing application. The message viewing application may display an amount of time remaining before the message is automatically deleted. In some embodiments, the message viewing application displays the message as obscured. In some embodiments, the method includes identifying, by the message viewing application, placement of the obscure viewer over the portion of the obscured message and unobscuring that portion while maintaining the remaining portions of the message obscured. In some embodiments, the message viewing application only allows portions of the message to be viewed unobscured at a time during the predetermined time before the message is automatically deleted.

In some aspects, the present solution is directed to a system for providing a secure and private message for limited viewing. The system includes a message viewing application executable on a device configured to receive a notification of an encrypted message stored on a server, retrieve the encrypted message from the server and decrypt the encrypted message to a message in memory of the device. The message has a predetermined expiration time comprising a predetermined time from receipt of the message upon which the message is automatically deleted for viewing via the message viewing application. The predetermined time be a number of seconds or a number of minutes. The message viewing application is further configured to provide the message from memory, for obscured viewing, only for the predetermined time between receipt of the message and automatic deletion of the message by the message viewing application upon expiration of the predetermined expiration time for the message, and an obscure viewer that displays an unobscured view of a portion of the message at a time while maintaining remaining portions of the message obscured.

In some embodiments of the system, the server is configured to receive a request from a second message viewing application, executable on a second device, to send the message to a user of the message viewing application. The server is configured to receive the message from the second message viewing application securely and storing the message as the encrypted message on the server. In some embodiments of the system, the server is further configured to receive the predetermined expiration time for the message specified from the second message viewing application.

In some embodiments of the system, the message viewing application is configured to store the encrypted message to storage of the device. In some embodiments of the system, the message viewing application is configured to decrypt the stored encrypted message and storing the message from the decryption only in the memory of the device.

In some embodiments of the system, wherein the message viewing application is configured to receive a selection by a user to view the message within the message viewing application, the message viewing application displaying an amount of time remaining before the message is automatically deleted. In some embodiments of the system, the message viewing application is configured to display the message obscured. In some embodiments of the system, the message viewing application is configured to identify placement of the obscure viewer over the portion of the obscured message and to unobscure that portion while maintaining the remaining portions of the message obscured. some embodiments of the system, the message viewing application is configured to only allow portions of the message to be viewed unobscured at a time during the predetermined time before the message is automatically deleted.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a cloud computing environment comprising client device in communication with cloud service providers;

FIGS. 1C and 1D are block diagrams depicting embodiments of computing devices useful in connection with the methods and systems described herein;

FIG. 2 is an block diagram depicting a system for securely and privately delivering content between clients;

FIG. 3 is an illustration of an embodiment of the graphical interface for privately and securely sending message in connection with the methods and systems described herein;

FIG. 4 an illustration of the multiple graphics layers of a system for obfuscating content, similar to the exemplary embodiment of the message viewer in FIG. 3;

FIG. 5 is an illustration of an embodiment of a image viewer in connection with the methods and systems described herein;

FIG. 6 is an illustration of an embodiment of a multi-content viewer in connection with the methods and systems described herein;

FIG. 7 is a flow chart of a method for securely and privately delivering content from a sender to a recipient in connection with the methods and systems described herein.

### DETAILED DESCRIPTION

For purposes of reading the description of the various embodiments below, the following descriptions of the sections of the specification and their respective contents may be helpful.

Section A describes a network environment and computing environment which may be useful for practicing embodiments described herein.

Section B describes embodiments of systems and methods for securely and privately delivering content from a first client device to a second client device.

### A. Computing and Network Environment

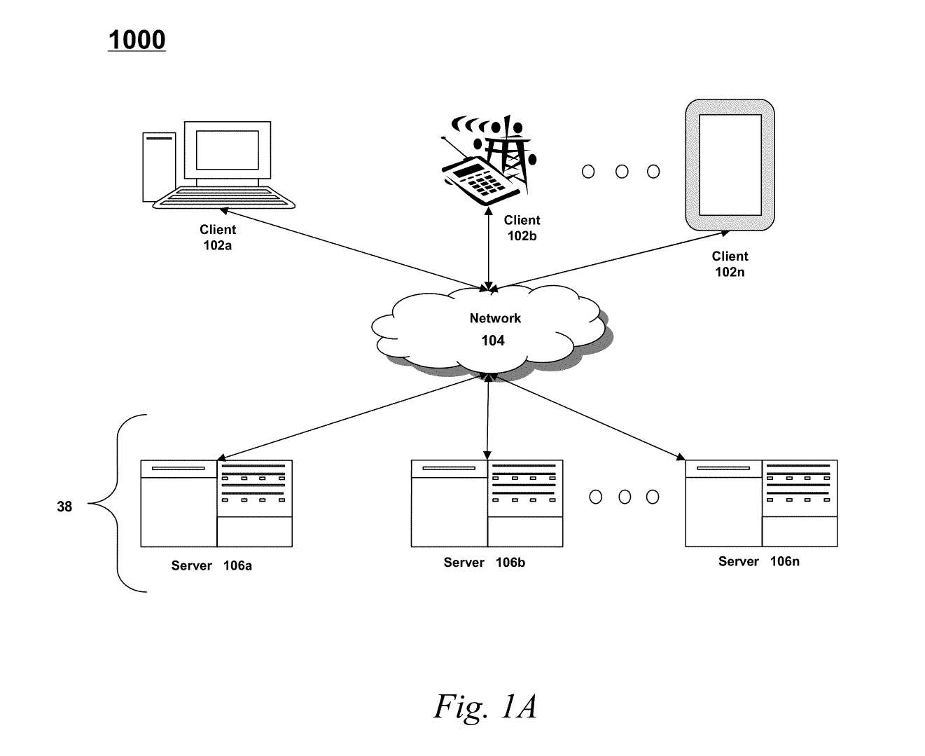

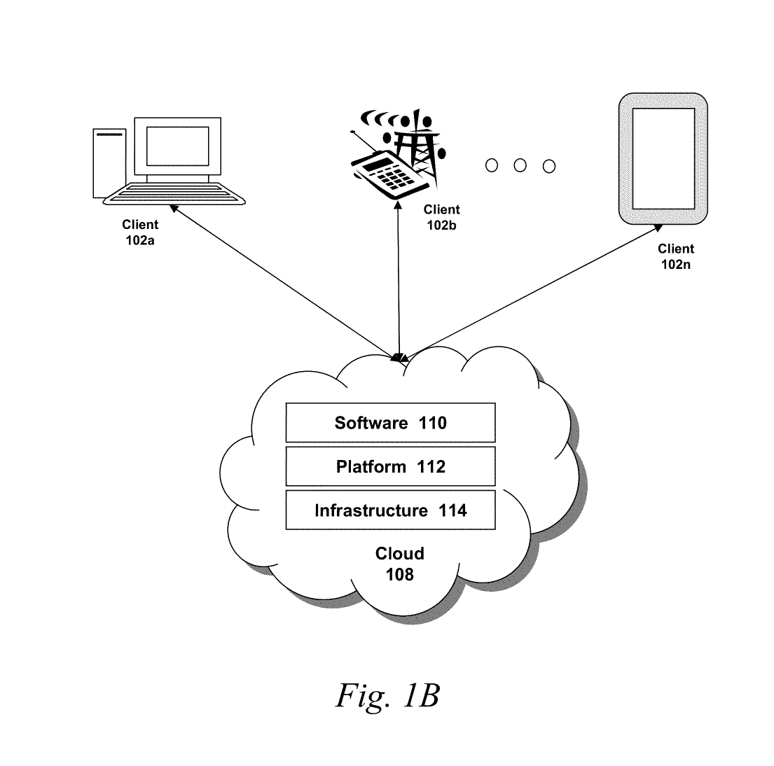

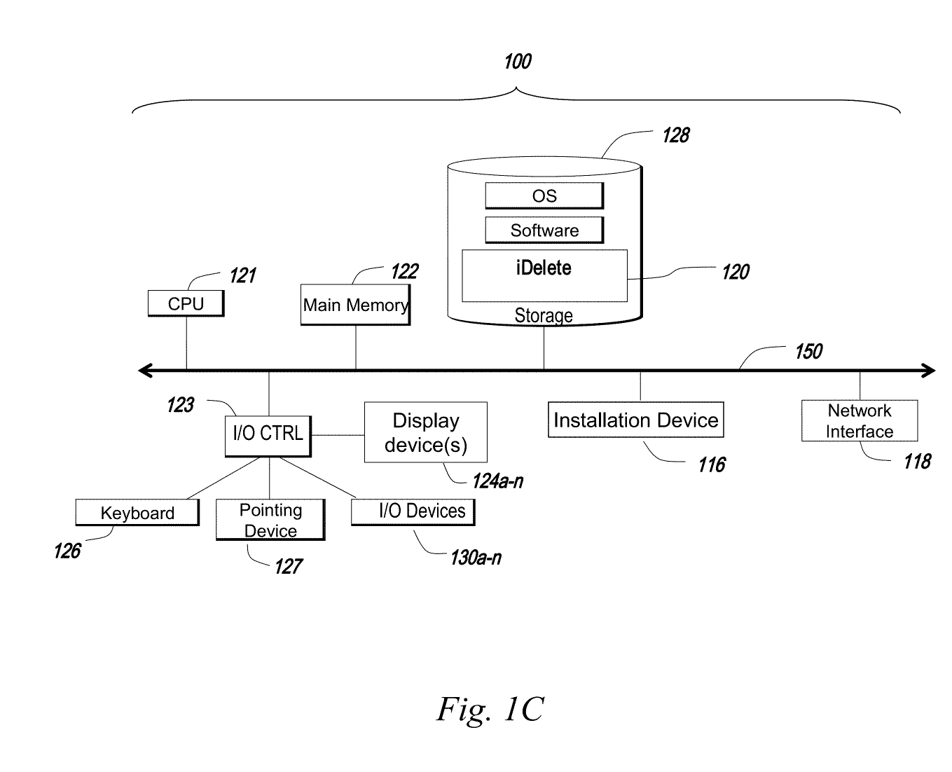

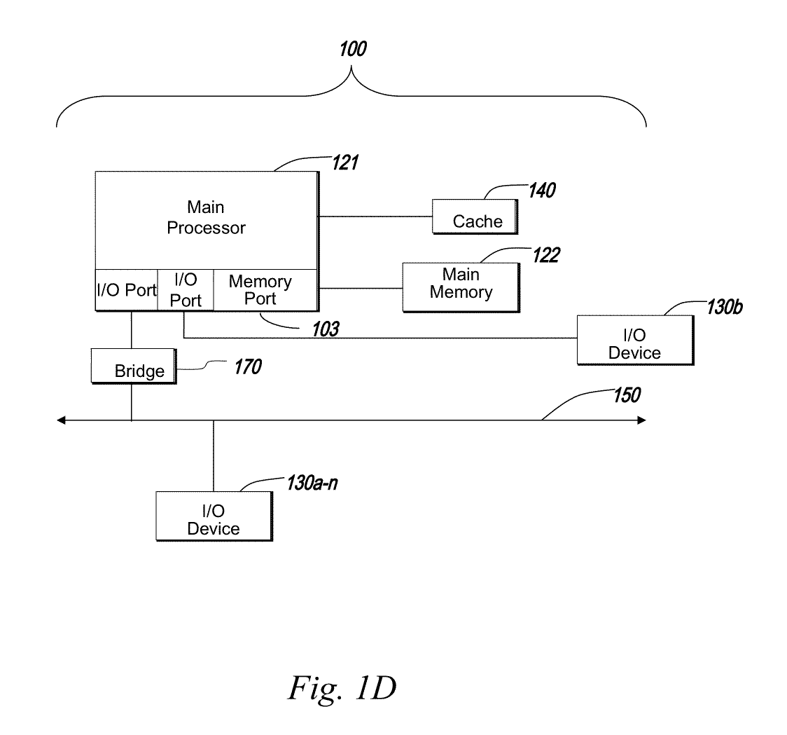

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-3000 (IMT-3000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of iDelete System 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the systems and methods described herein, such as the iDelete software. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3000, WINDOWS Server 3012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. iDelete System

The present disclosure is directed to systems and methods for securely delivering content from one client device to another. Additionally, the present solution may further provide a system and method for ensuring that once the content has been delivered to an intended client, that it is not subsequently redistributed to additional clients or viewed by unintended parties. The present solution uses a combination of cloud storage and/or obscuring with self-destruct capabilities to provide additional layers or levels of security for sending content between users, such as via texting between mobile devices.

For example, one implementation of the systems and methods described herein is for the safe and private delivery of content from a first smart phone to a second smart phone. The content delivered between the smart phones may be a text message. The text message may include text, images and/or video that a first user does not wish to be viewed by unintended recipients and/or distributed beyond the intended first recipient or to otherwise be viewed by the intended recipient in a guarded and/or limited way. By using the combination of cloud storage and/or obscuring with self-destruction, from the time the recipient receives the message until the time the message self-destructs, the present solution prevents and/or significantly hinders the recipient from obtaining, accessing or copying, such as via a picture snapshot or file copying, all of the content of the message.

As discussed below, the system and methods described herein restrict the delivery of content to only intended recipients by combining a number of independent security measures. These security measures may include combining self-destruction (e.g., auto-deleting messages) with content obscuring. Furthermore, the cloud based system described herein, further ensures that messages and the content within the messages may not be viewed by third party applications running on the smart phone or other client devices.

While the invention has been particularly shown and described with reference to specific embodiments, it should be understood by those skilled in the art that various changes in form and detail may be made therein without departing from the spirit and scope of the invention described in this disclosure.

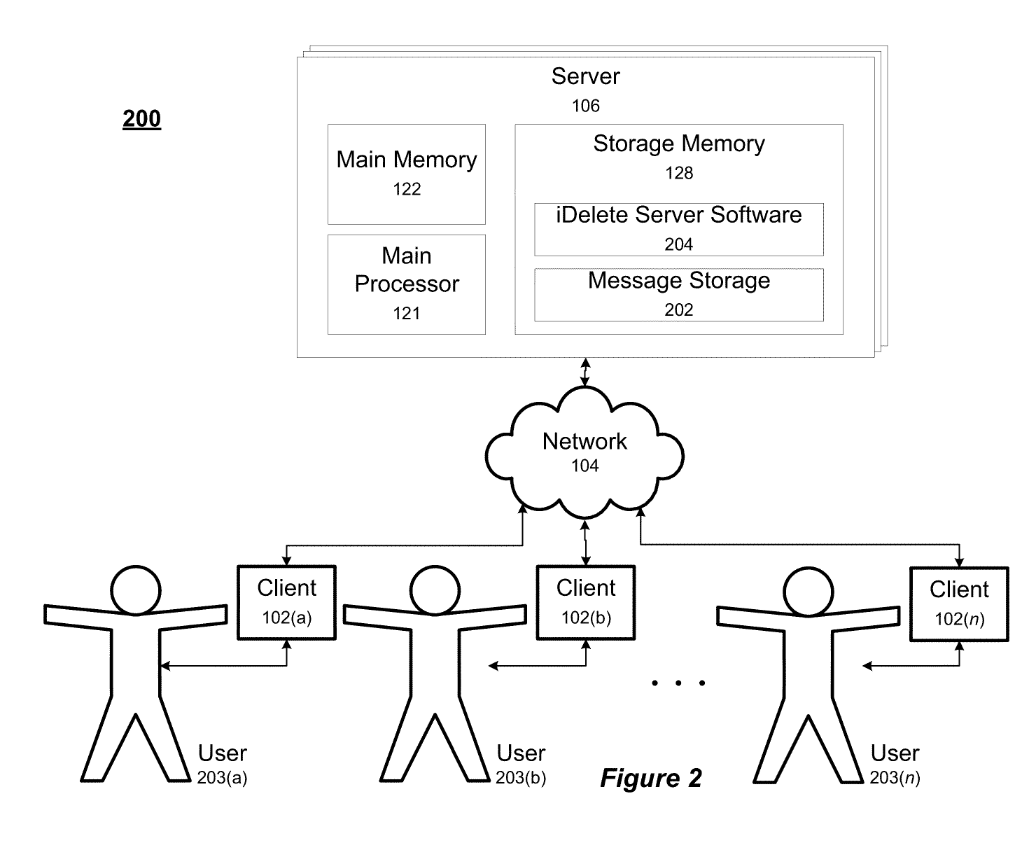

FIG. 2 illustrates an embodiment of an iDelete Network 200. The iDelete Network 200 may include a plurality of clients 102(a)-(n) executing the iDelete 120 computer program introduced above in relation to FIG. 1C. A user 203 may initiate the transmission of content from a first client to a second client. The clients 102 may deliver the content to one another via a network 104. In some implementations, a first client 102 delivers the content to at least one server 106. The server 106 may execute the iDelete server software 204. The server 106 may, in turn, deliver the content to a second client 102. In the process of transmitting the content from the first client to the second client, the server 106 may store the content in the message storage 202 of the storage memory 128. The content may be delivered to more than one client 102. Additionally, the servers 106 may actively push the content to the client 102. For example, in one implementation, a user may activate the iDelete software 120 and request content stored on the server 106, and in other implementations, the server 106 may push the content to the client 102, regardless of whether the user is actively using the iDelete software 120.

The iDelete Server 204 may comprise one or more applications, programs, libraries, scripts, services, processes, task and/or any type and form of executable instructions executing on one or more servers 106. The iDelete software 120 may include one or more message viewing applications 350 described in detail below. The message viewing application may be the client application or client-side application of the iDelete software 120 that interacts with and/or communicates with the iDelete server. The message viewer may comprise an application, program, library, script, service, process, task and/or any type and form of executable instructions executing on a device, such as a mobile device or client of a user. Although generally referred to as a message viewing application, the message viewing application may be used for creating and sending messages and receiving and viewing messages via the iDelete server or system.

The message viewing application and iDelete server may be designed, constructed and/or configured to communicate securely between each other, such as via any secure communication protocols, for example, Secure Socket Layer, Transport Layer Security or Secure HyperText Transfer Protocol (HTTPS). The message viewing application and iDelete server may be designed, constructed and/or configured to encrypt and decrypt messages within secure communications using any type and form of encryption algorithm of a desired strength or having desired properties. The message viewing application and iDelete server may negotiate which type of encryption to use or which encryption is commonly supported between them. The message viewing application and iDelete server may be designed, constructed and/or configured to store messages securely to storage, such as storing messages in their encrypted form to storage or storing messages to an encrypted storage.

Still referring to FIG. 2, in some implementations, the iDelete software 120 provides a private and secure system and methods for users to deliver content from one client 102 to another client 102. The content distributed between the clients 102 of the iDelete network 200, may include, but is not limited to, text content, multimedia content, website content, audio content, video content, image content or any combination thereof. For example, the system 200 may allow a first client 102 to send a MMS message containing text and a video to a second client 102. In some embodiments, the message viewing application described herein may be built into an texting application, email application, communication application or social networking application. In some embodiments, the systems and methods described herein may be built into any type and form of texting application, email application, communication application or social networking application.

As discussed above, content may be transmitted from a first client 102 to a second client 102 via the network 104 and server 106. The iDelete server software 204 may direct the transmission of content between the clients 102. In some implementations, the iDelete server software 204 may temporarily store content for later retrieval in the server's message storage 202. The server may never store the content in the message storage 202, but rather the content may be temporally stored in the server's main memory 122. Discussed in greater detail below, in some implementations, the server 106, via the iDelete server software 204, may temporarily store received content until the expiration of an expiration timer.

Discussed in greater detail below in reference to the embodiments of the user interface, the iDelete software 120 provides secure and private communications through a plurality of independent measures. These security and privacy measures may include overlaying a obfuscating filter to any content displayed on the screen of the client 120; automatically deleting the content from clients 102 and servers 106 involved in the creation and delivery of the content; encrypting the content during times of storage and transmission; or any combination thereof.

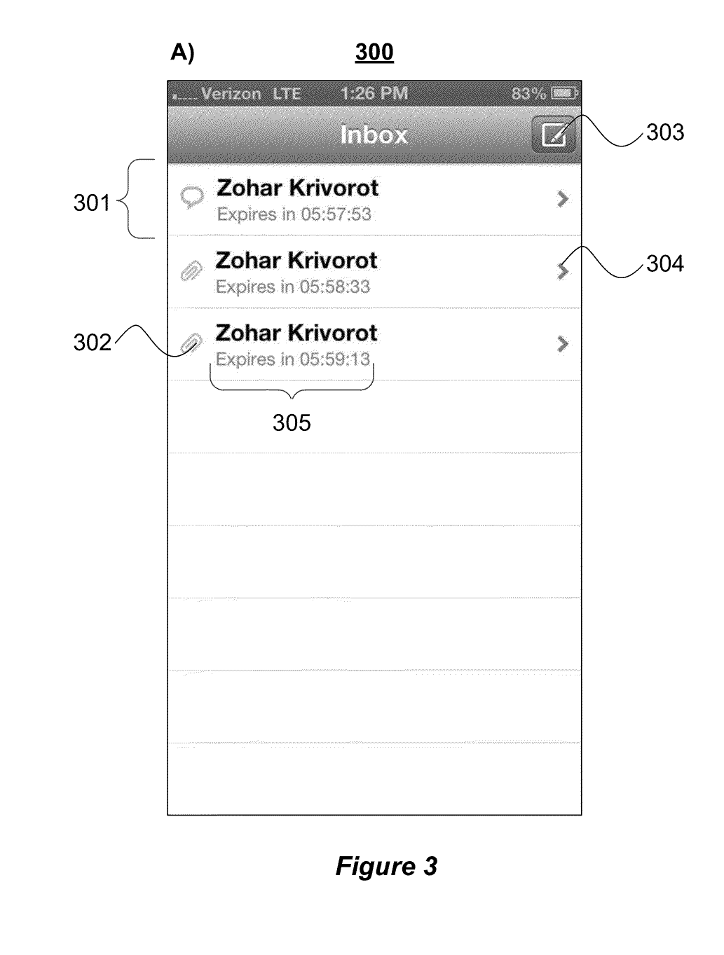

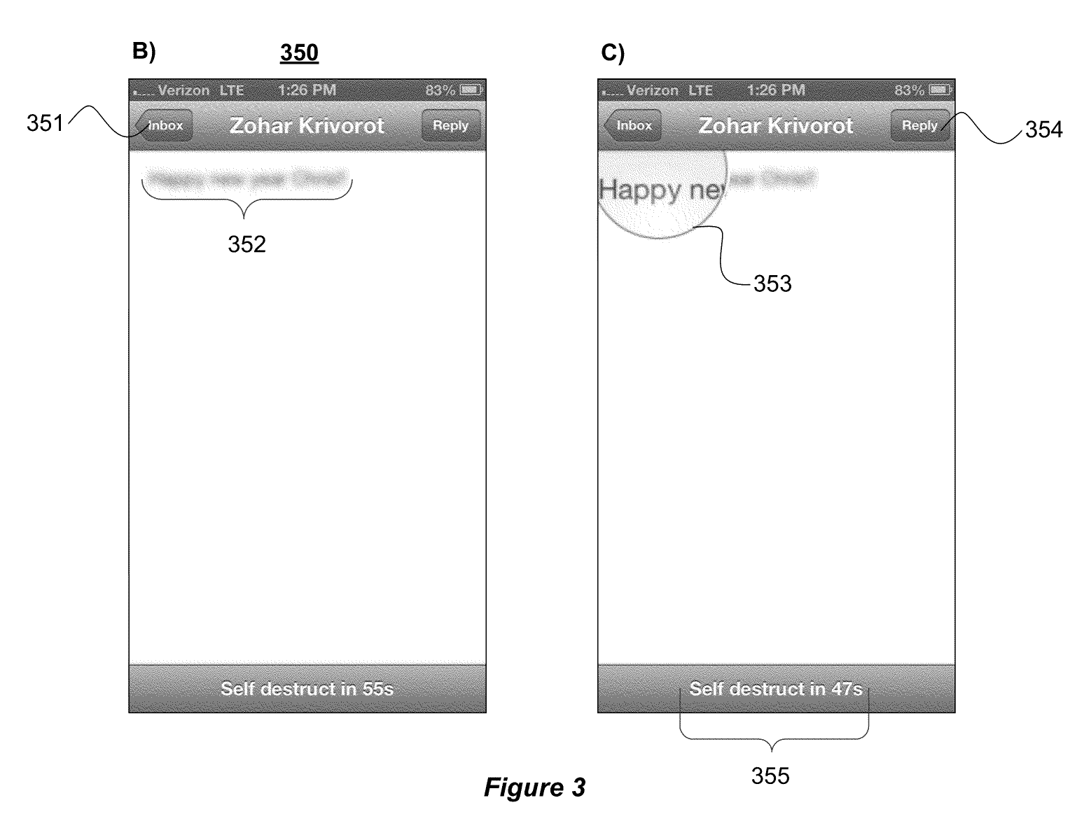

FIG. 3 illustrates an implementation of the iDelete software 120. More specifically, FIG. 3A illustrates the inbox 300 of the graphical user interface (GUI) for the iDelete software 120 according to one embodiment. The inbox 300 may allow the user to view a plurality of message previews 301. In some implementations, the displayed message previews 301 are updated whenever a user enters the inbox 300. In other implementations, the message previews 301 may only be updated at specific intervals or upon the request of the user. The message previews 301 may include information about the sender of the message. In certain implementations, the message preview 301 indicates if the message includes an attachment by displaying an attachment icon 302. The attachment icon 302 may indicated the type of content attached to the message. The message preview 301 may also include an expiration timer 305. Discussed in greater detail below, in some implementations, a user may request that a message be auto deleted at a specific time. The expiration timer 305 may indicate the time remaining before the message is auto deleted.

In some implementations, the inbox 300 also includes a compose button 303. Selecting the compose button 303 may display a composition GUI where the user may create or compose new content. The compose button 303 may also display a GUI that allows users to create content from preselected types of content. For example, responsive to selecting the compose button 303, the user may be presented with the option to create a new text message, a new video message, or a new picture message.

Selecting the message link 304, or in some implementations, selected anywhere in the message preview 301, may display the message in the message viewer application or message viewer 350 of FIG. 3B. The message viewer 350 may include a return to inbox button 351, which may take the user back to the inbox 300. In certain implementations, the message viewer 350 may include a reply button 354. The reply button 354 may display a composition GUI similar to the GUI displayed by the selection of the compose button 303. Selection of the reply button 354 may auto-populate the recipient field of the newly created content message with the contact information of the sender. The message viewer 350 may also include an expiration time 355. In some implementations, the expiration time 355 may flash, blink, and/or change colors when the timer is below a set threshold.

The content may be obfuscated by any type and form of obfuscation. In some implementations, content may be obfuscated via or by blurring the content. Other obfuscation methods may be employed such as, but not limited to, applying a secondary image over the content, distorting the content, hiding/covering the content, applying an algorithm to the content to change the content, and/or rearranging the pixels of the content. In some implementations, the content may be obfuscated by leaving blank or invisible until the obfuscation viewer is applied.

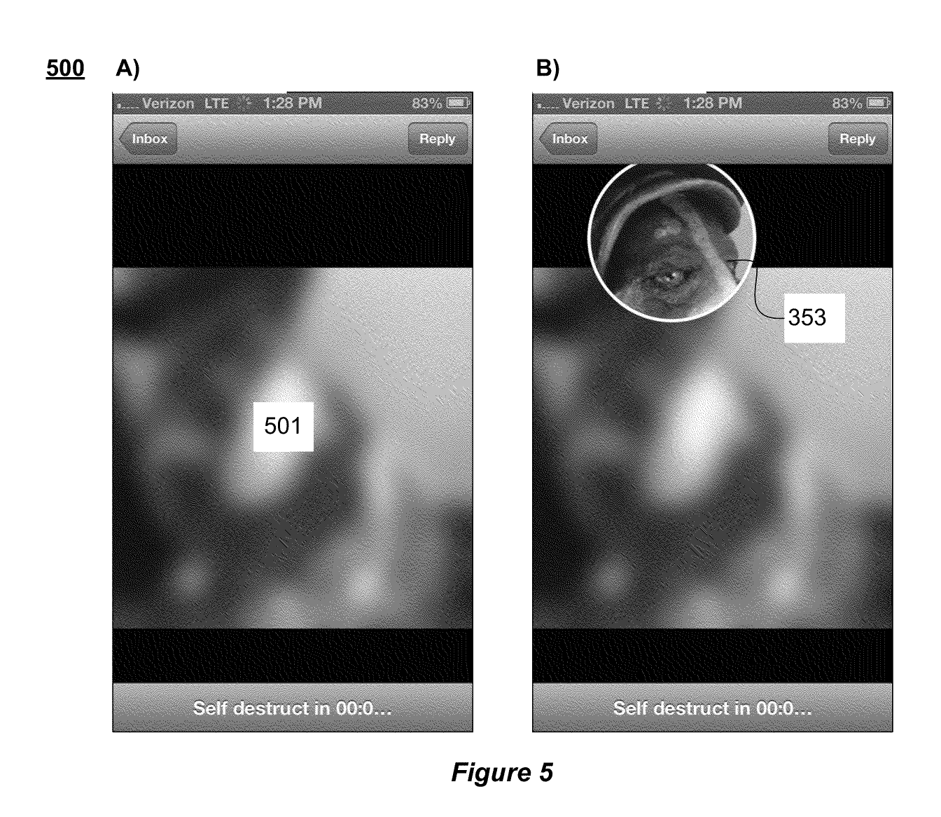

As shown in relation to FIG. 5, in some implementations, the obfuscation encompasses the entire content. in some implementations, the obfuscation encompasses those portions of the content that are to be consumed or viewed by a recipient. For example, the obfuscation may not obfuscate spaces between text or content. In other implementations, the user may configure the obfuscation, via the message viewing application or iDelete server or software, such that the obfuscation only occupies a specific portion of the content and/or is of a particular shape. For example, if a user sends a text message that includes a password the user may select to have only the password obfuscated. In some implementations, the user may configure the obfuscation such that the obfuscation only is applied to certain types of content, such as to text, pictures or video. In some implementations, the user may configure the obfuscation such that the obfuscation only is applied to certain words or phrases in text.

The obfuscated content may be viewed using any type and form of obfuscation viewer or viewing ring 353. The obfuscation viewer may comprise a circle, such as giving the user a flashlight view of the content as illustrated in the figures. Via the obfuscation viewer, the user can see the underlying content (e.g., text, picture or video) within the area provided by the obfuscation viewer while content outside the area provided by the obfuscation viewer is obfuscated. The obfuscation viewer may comprise any shape, such as a circle, oval, rectangle, square, diamond, etc. The size or area of viewing provided by the obfuscation viewer may be predetermined or configurable. The size or area of viewing provided by the obfuscation viewer may be proportional relative to the size of the content or the area occupied by the content. The size or area of viewing provided by the obfuscation viewer may be proportional relative to the type of content (text, picture or video). The size or area of viewing provided by the obfuscation viewer can be made smaller or larger based on a level of security desired. For example, the size and shape of the obfuscation viewer may be determined via configuration, automatically or otherwise based on the receiver or a level of security assigned to the receiver.

In some implementations, the type of obfuscation may be responsive to the type of content being obfuscated. For example, the obfuscation may be configured such that text is blurred and pictures are blacked out. In another example, the obfuscation viewer may be of a certain type and form for text (such as a circle or ring) and of another type and form for pictures or video, such as a square or rectangle.

In some implementations, the obfuscation viewer may be designed and constructed to be dynamic. The obfuscation viewer may change size or shape responsive to time, such as amount of time remaining to self-destruction. For example, the obfuscation viewer may grow larger in predetermined increments as the self-destruction timer gets closer to expiration. The obfuscation viewer may change size or shape responsive to location within the message viewer, such as changing between text and a picture or video. The obfuscation viewer may change size or shape responsive to finger or hand gestures in the case of a touch screen. For example, the size of the obfuscation viewer may be proportional or relative to a size of the finger touching the screen, the area of the finger touching the screen or the force of the finger upon the screen. In another example, the size and shape of the obfuscation viewer may change dynamically responsive to using two or more fingers, such as squeezing or separating fingers.

In some embodiments, the sender of the message may control the obfuscation viewer remotely. For example, the sender may change the size, shape and use of the obfuscation viewer after the message has been sent and/or while the receiver is viewing the message. For example, the sender may change the size, shape and use of the obfuscation viewer prior to self-destruction of the message. The server may provide an interface for the sender to control and/or change the size, shape and use of the obfuscation viewer and send those controls and/or changes to the receiver's viewing application to apply the change.

In some implementations, the obfuscation placed on the content is automatically deployed or placed on content responsive to rules and/or policies, such as ruled and/or policies put in place by the user and/or configured into the system. For example, the obfuscation may be selected based on the type of content, the receiver, the location of the sender and/or receiver, the type of device of the receiver, etc. or any combination thereof. For example, a user may configure a policy such that when a receiver is determined to be at the receiver's home the delivered content is not blurred; however, the content is blurred when the receiver is not at home or if the receiver's location cannot be determined. As another example, a user may configure a policy such that content delivered to a specific receiver is always blurred. In some implementations, the policies, rules, and or security settings may be updated, removed, or added after the content has been sent. In some implementations, the sender can force the deletion of the content from a recipient's client 102.

When viewing messages via the message viewer 350, the user may initially be presented with obfuscated content 352. In some implementations, the user deobfuscates the content by dragging a obfuscation viewer, such as viewing ring 353 over the content. In other implementations, the content may be deobfuscated by applying a password. In other implementations, the content may be deobfuscated for only short periods of time. For example, in addition to or in place of using the obfuscation viewer 353, a user may view the entire content deobfuscated, but only for 1 second at a time. As illustrated in FIG. 3C, in some implementations, only a portion of the content is deobfuscated at any given time. In other implementations, the user may deobfuscate the entirety of the content at a single instance in time. The obfuscation viewer 353 may be resized. The resizing may be selected by the viewer of the message. In some implementations, the sender of the message sets the size of the obfuscation viewer 353 for the recipient.

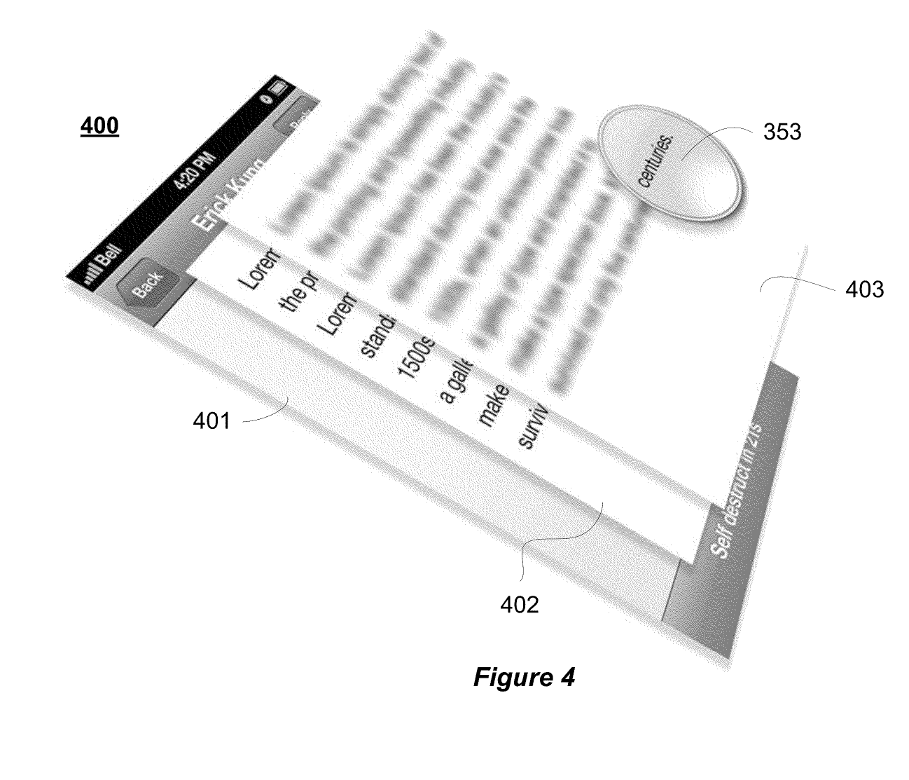

FIG. 4 illustrates an embodiment of the obfuscation layer that may be applied to the content. Responsive to entering the message viewer 350 described above, the iDelete software 120 may download and decrypt the message or content. The iDelete software 120, such as via the message viewer application, may place the decrypted content in main memory 122 and not storage 128. The iDelete software, such as via the message viewer application, may then create a content layer 402 to display over the message viewer layer 401. The obfuscation layer 403 may be placed over the content layer 402. To view the content layer 402, a user may move the obfuscation viewer 353 across the obfuscation layer 403. In some embodiments, the iDelete software 120, such as via the message viewer application, automatically removes the obfuscation within the obfuscation viewer 353, displaying the content layer 402 directly below the obfuscation viewer 353. In other implementations, the obfuscation layer is not a layer placed on top of the content layer. In some implementations, the obfuscation is incorporated into the content. For example, the content may be processed with a first algorithm that results in blurred content. Responsive to the placement of the obfuscation viewer 353, the iDelete software 120, such as via the message viewer application, may process a portion of the content with a second algorithm that reverses the effect of the first algorithm. These algorithms may be encryption algorithms or other such obfuscation algorithms that are not accessible outside the iDelete software 120.

FIG. 5 illustrates an embodiment of a picture viewer 500. In some implementations, the picture viewer 500 is an embodiment of a message viewing application 350 discussed above that may display multimedia content. In some embodiments, the message viewing application 350 comprises the picture viewer or the functionality thereof. The picture viewer 500 may display a plurality of multimedia content items 501. For example, the multimedia content may be, but is not limited to, an image, video, webpage, GIF, or any combination thereof. As discussed above, the deobfuscated content may be viewed within the obfuscation viewer 353. In some implementations, the content may still be viewed by a user when the expiration timer had expired; however, the content may no longer be deobfuscated.

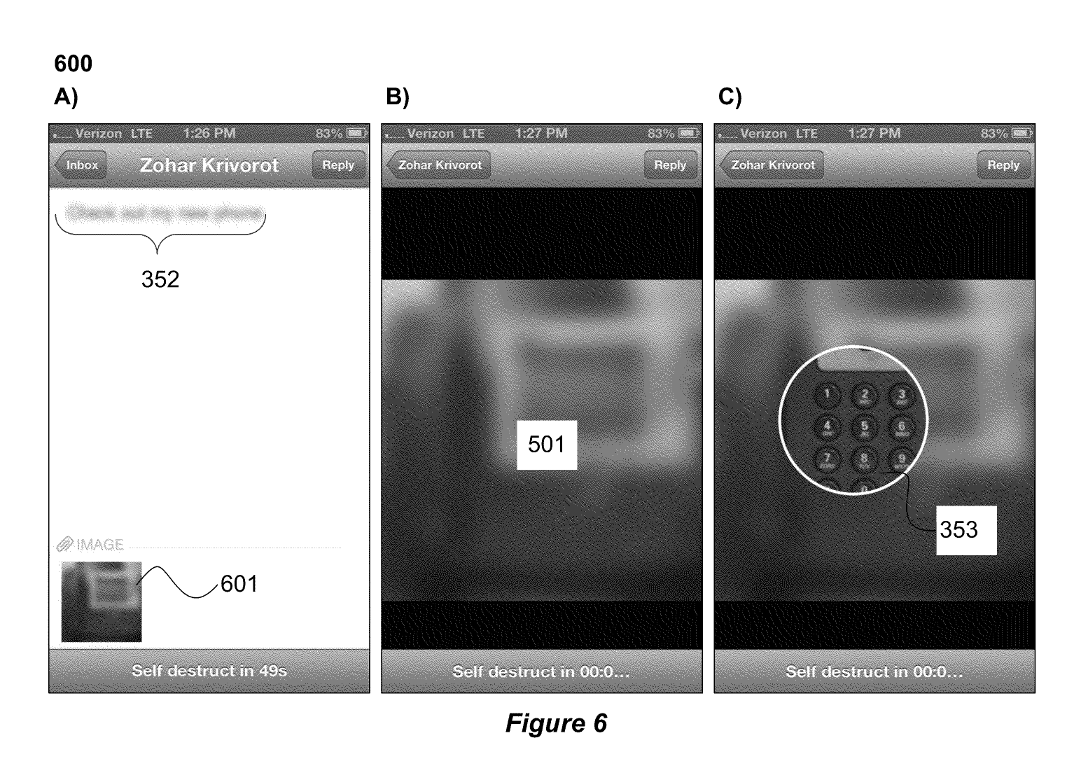

FIG. 6 illustrates an embodiment of a multi-content viewer 600. The multi-content image viewer 600 may display multiple types of content and/or multiple content items. For example, the multi-content viewer 600 may display obfuscated text 352 and an obfuscated image 601. In some implementations, the multi-content image viewer 600 is an embodiment of a message viewing application 350 discussed above that may display multiple types of content. In some embodiments, the message viewing application 350 comprises the multi-content image viewer or the functionality thereof. As an additional example, the multi-content viewer 600 may display a message that includes two obfuscated images 601 and no obfuscated text 352. In some implementations, selecting a content item in the multi-content viewer 600 presents the user with the content item in appropriate type of content viewer. For example, as illustrated in FIGS. 6A and 6B, selecting the obfuscated image 601 may present the user with the image viewer 500 discussed above.

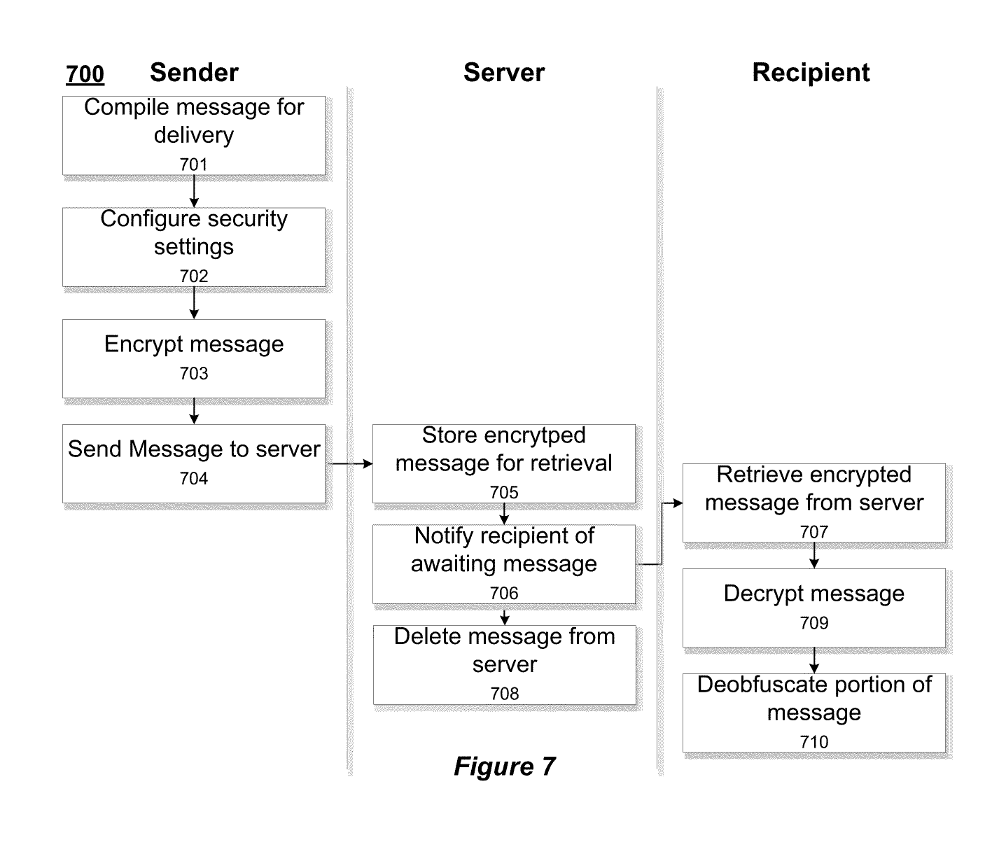

FIG. 7 illustrates a flow chart of a method 700 for generating, storing, and viewing content according to an embodiment of the above described system. In some implementations, the message is compiled for delivery by the sender (step 701). The sender may configure the security settings associated with the message (step 702). Responsive to the selection of the security settings, the message is encrypted (step 703) and sent to a server (step 704). Responsive to receiving the message, the server stores the encrypted message (step 705) and notifies the recipient of the awaiting message (step 706). The recipient may retrieve the message from the server (step 707). Responsive to the delivery of the message, the server may delete the encrypted message stored on the server (step 708). Having received the encrypted message, the recipient decrypts the message (step 709). The method 700 concludes with the deobfuscation of a portion of the message (step 710).

As set forth above, at step 701, the method 700 includes a user compiling content for delivery. In some implementations, the user may compile the content with the interfaces discussed in relation to FIGS. 2-6. In other implementations, the user may create and/or view content via a web-page. In other embodiments, iDelete software interfaces described above may provide a web portal to the server 106 such that the content created by the user is created on the server 106 and not stored locally on the client 102. In some implementations, the content is a text message, media file, image, video, or other type of content as described above. The user may also import content created with other computer programs running on the client 102. For example, the user may have taken a picture with a phone's camera feature. The user may select the picture to include as the content. In some embodiments, the user types in a message via the message viewing applications. In some embodiments, the user creates content and message via the message viewing application with integration to a mobile device of the user, such as obtaining images or videos from storage, memory or other applications of the mobile device.

At step 702, the user configures the security settings. The user may set the security settings as a global security setting and/or the setting may be individually set for each message. For example, the user may configure the iDelete software 120 such that every message sent includes a predefined set of security settings. In some implementations, the security settings may include, but are not limited to adding an obfuscation layer, adding an auto-delete setting to the message, requiring a PIN to view the message, setting an expiration timer, or any combination thereof. The obfuscation layer may be similar to the obfuscation layers described above in relation to FIGS. 3-6. The auto-delete feature may also be referred to as a “self-destruct feature.” The user may configure the security settings via the message viewing application in communication with the iDelete server. As such, the iDelete server may receive security setting specified or configured by the user via the message viewing application.

Via the security settings, a message may have a predetermined expiration time or auto-delete time. The predetermined expiration time may be a predetermined time from receipt of the message, by the client device or message viewing application, upon which the message is automatically deleted for viewing, such as via the message viewing application. The predetermined expiration time may be a predetermined time from viewing of the message, by the client device or message viewing application, upon which the message is automatically deleted for viewing, such as via the message viewing application. The predetermined expiration time may be a predetermined time from receipt or viewing of the message by the client device or message viewing application upon which the message is automatically deleted from memory and/storage of any or all iDelete software, such as the iDelete server and the server's memory and/or storage and the message viewing application and the client's memory and/or storage. The predetermined time for the expiration time may be specified or configured with any type and form of temporal constraints, such as by number of seconds, minutes, hours or day. The predetermined time for the expiration time may be specified or configured as a specific time of the day or a specific date and time. The predetermined time for the expiration time may be specified or configured as an amount of time the recipient may spend with the message viewed. The predetermined time for the expiration time may be specified or configured as a total amount of time the recipient may view the message for. In some implementations, upon a recipient viewing the message, the auto-delete timer begins, and when the auto-delete timer expires the message is automatically deleted from the recipient's client 102. The auto-delete timer may not begin until the recipient views the message, such as via the message viewing application. The user may also configure an expiration timer that deletes the message a set time after the message was sent. In some implementations, the expiration timer deletes the message when the timer expires regardless if the recipient viewed the message. The message viewing application and/or the iDelete software may provide a user interface with selectable user interface elements for a user to select the predetermined time for expiration.

At step 703, the message is encrypted, such as by the message viewing application. The message may be composed and stored only in the memory 122 of the client 102, such that the message is never saved to the storage 128 of the client 102. The message may be encrypted in memory with an encryption algorithm. For example, the message may be encrypted with a local 256-bit encryption. In some implementations, the user may select the type of encryption used, such as via an interface of the message viewing application or iDelete software. In some embodiments, the client or message viewing application stores the encrypted message locally to storage. In some embodiments, message viewing application sends the message unencrypted (e.g., plain text) via secure communications to the server and the server encrypts the message, such as upon receipt.

At step 704, the client or message viewing application sends the message to the server. The message may be sent to the server over a network 104. In some implementations, the network connection is a secure network connection, such as SSL or HTTPS. In some embodiments, the message viewing application transmits the message or content via a secure connection to the iDelete server. In some embodiments, the client device uploads the message or contents via a secure interface of the iDelete server. The user may identify an email, phone number, account identifier, user name or other electronic identifier of a second user to which to send the message. The user may for example enter or select the mobile phone number of the second user in the message viewing application to send the message. In another example, the user may enter or select via the message viewing application the user name of a second user with an account maintained by the iDelete server.

Responsive to sending the message to the server, the iDelete software 120 on the client device, such as the message viewing application, may delete the message or content from memory and/or storage of the device, such as by flushing the portion of memory 122 where the message was stored or temporally held. In some implementations, the message may be sent directly from a sender to a recipient, without the server intercepting the message.

At step 705, the encrypted message is stored on the server. In some implementations, the message may be stored only in the memory 122 of the server 106. Responsive to the receipt of the message, the server 106 may send the message immediately, or upon receipt to the recipient. In other embodiments, responsive to receiving the message, the server 106 stores the encrypted message in the message storage 202 of the server's storage 128. The encrypted message may be stored such that the server is unable to decrypt the message. In some implementations, the client device stores and/or maintains the key to decrypt the message. In some implementations, the server does not receive the key from the client to decrypt the message. In some implementations, a first client shares the encryption key with a second client that is used to decrypt the message. In some embodiments, only message viewing applications have the keys to encrypt and/or decrypt messages and the server stores encrypted messages for retrieval by such message viewing applications. In some embodiments, the server stores, manages, controls and/or distributes the keys to encrypt and/or decrypt messages by the message viewing applications.

At step 706, responsive to receiving the message, the server notifies the recipient client of the awaiting message. In some implementations, the server holds the message and notifies the recipient at a time specified by the user sending the message. In some implementations, the server 106 may push a notification to the client 102. In other embodiments, the server may send out the notifications on a rolling basis. For example, the server 106 may collect incoming messages for a predetermined time period, such as 15 minutes, and send the notifications at the end of each predetermined time period window. In yet other embodiments, the server 106 may hold the notification. In such implementations, the notification may be held until the recipient, such as via the message viewing application, connects to the server 106 to determine if there are any pending messages for delivery. In some embodiments, the message viewing application provides a user interface element that indicates to the user that there is a new messages or messages to retrieve from the server. In some embodiments, the message viewing application comprises a message queue showing the number of and/or status of messages on the server and/or retrieved from the server.

At step 707, responsive to receiving the notification, the recipient via the message viewing application retrieves the encrypted message. The message may be retrieved through a secure network connection. For example, the encrypted message may be retrieved by the recipient with a HTTPS GET method. The retrieved, encrypted message may be stored in only the device's memory 122 and not in the storage 128 of the client 102. For example, the message viewing application may only temporarily store the encrypted message in the memory 122 such that the encrypted message may not be accessed by another computer program. In some embodiments, the encrypted and/or decrypted messages may be held in a memory that is reserved for or allocated to the message viewing application and for which other programs cannot access. In some embodiments, the encrypted message is stored encrypted to the storage of the device and is only decrypted in memory of the device. For example, the encrypted message may be stored as an encrypted file to storage or to encrypted storage of the device.

In certain implementations, the client 102 may re-retrieve content form the server 106 if the content has expired. In some implementations, the content may remain on the server 106 until the expiration timer of the content expires. In such implementations, upon activation, the message viewing application of the client device may check the server 106 for any non-expired messages. The client 102 may retrieve any available messages. When the user 203 terminates the iDelete software 120 session, all retrieved messages may be flushed from the client's memory 122. In such implementations, the client 102 may re-retrieve available messages each time the message viewing application is executed. In some implementations, retrieving the encrypted message does not include creating a local copy of the encrypted message. For example, the message viewing application acts as a viewer of messages stored on the server 106.

At step 708, the server deletes the encrypted message from the server's memory and/or storage. In some implementations, the deletion of the encrypted message from the server occurs congruently with step 707. In other implementations, there is a specific or predetermined time delay before the deletion of the encrypted message on the server. For example, the server may wait until receiving confirmation of the delivery of the encrypted message to the recipient before deleting the message from the server. In other implementations, the content may be deleted from the server 106 responsive to the expiration of the expiration timer such that the content remains available on the server 106 for re-retrieval until the expiration timer expires. In other implementations, the content may be deleted from the server upon request of the sender sending the message and/or upon indication that the recipient received or read the message. The message may be deleted such that the message may not or never be recovered from the server. For example, the sectors of the hard drive that previously stored the encrypted message may be over written a plurality of times.

The message is decrypted by the recipient via the message viewing application at step 709. The message viewing application may decrypt the message without saving any portion of the message to the device's storage 128. The message viewing application may hold the encrypted message in memory and decrypt the encrypted message in memory of the message viewing application. The message viewing application may hold the encrypted message in storage and decrypt the encrypted message from storage into memory of the message viewing application. The message viewing application may only hold the plain text or decrypted version of the message in memory accessible only by the message viewing application.

In some implementations, the encrypted and/or decrypted message be stored in memory and/or storage of the device obscured such that only via the viewer of the message viewing application is the message unobscured. For example, the iDelete server and/or sender's message viewing application may obscure the message before encrypting and sending to the recipient. In another example, the recipient's message viewing application upon decryption may obscure the message held in memory of the recipient's device such that only the obscured message is accessible in memory of the device.

The sender and recipient may negotiate the encryption algorithm without the server's involvement such that the server never knows the encryption algorithm and never processes any of the required keys to decrypt the message. In some implementations, the message is automatically decrypted by the message viewing application in memory. In other implementations the message is decrypted responsive to a request from a user of the recipient device. The user may have to input a password prior to the recipient device decrypting the message.

The message viewing application may present, display or provide the message or an indicator or identifier of the message in a message queue or other user interface element for the user (e.g., recipient) to select for viewing. The message viewing application may receive a selection by a user to view the message. The message viewing application may display an amount of time remaining before the message is automatically deleted or otherwise expired in accordance with the configured predetermined expiration time. The message viewing application may present, display or provide such an amount of time remaining for all messages in the message queue.

The message viewing application displays the selected message in a window or user interface controlled and managed by the message viewing application. In some implementations, the entire message is displayed obscured. In some implementations, a default portion of the message is displayed unosbcured while all remaining portions are show obscured. For example, the message may be displayed obscured except for a portion over which the obscured viewer is currently placed or located. For example, the message may be displayed obscured except for a portion over which the obscured viewer is initially by default configuration placed or located.

At step 710, the recipient deobfuscates a portion of the decrypted message. A user may use an interface similar to the above described embodiments of FIGS. 2-6 to instruct the message viewing application to deobfuscate a portion of the message. The message viewing application may identify placement of the obscure viewer over a portion of the obscured message and unobscure that portion while maintaining the remaining portions of the message obscured. The message viewing application may only allow portions of the message to be viewed unobscured at a time, via the obscure viewer, during the predetermined time before the message is automatically deleted or otherwise the predetermined expiration time expires. As the user of the message viewing applications moves, such as via touch screen with their fingers, the obscure viewer over different portions of the obscures message those portions become unobscured with such movement while the once unobscured portions become obscured again. In some implementations, there may be a predetermined delay of switching from unobscured to obscured (and/or vice versa) responsive to movement and placement of the obscure viewers. In some implementations, the message viewing application may wait until a predetermined period of the obscure viewer being idle before switching from obscured to unobscured and/or vice versa.

In some embodiments, the iDelete software 120 and/or message viewing application may restrict the number of times a specific portion of the message may be deobfuscated. In some implementations, any portion of the message may only be unobscured a predetermined number of times, such as once, twice or three times. In some embodiments, while the message viewing application has the message and/or the user is viewing the message, the message viewing application may receive changes in the expiration time, the configuration of the obscure viewer and/or any security settings. For example, a user via the iDelete server or via their message viewing application in communication with the iDelete server may request such changes. Responsive to such changes, the message viewing application of the recipient may change the expiration time, the configuration or use of the obscure viewer or any security settings accordingly. For example, the sending user may allow the recipient to view the message for a predetermined time period unobscured or extend the expiration time. In another example, the sending user may change the size and shape of the obscure viewer to allow the recipient to view larger portions of the message unobscured.

In some implementations, responsive to expiration of the predetermined expiration time, the recipient's message viewing application automatically deletes the message from the message viewing application and flushes or deletes the message from the memory of the device and deletes any encrypted versions of the message stored in storage of the device. In some implementations, even if the user is in the middle of viewing the message, the message viewing application deletes the message from view via the message viewing application responsive to the expiration of the predetermined expiration time. In some embodiments, a notification is sent, by the iDelete server or recipient's message viewing application, to the sender (e.g., senders message viewing application) responsive to the recipient retrieving the message, viewing message, deleting the message, or any combination thereof. Responsive to these notifications, the iDelete server may delete the message from the server, such as from the server's storage and/or memory.

1. A method for providing a message for limited viewing, the method comprising:
(a) receiving, by a message viewing application executing on a device, a notification of an encrypted message stored on a server;
(b) retrieving, by the message viewing application, the encrypted message from the server;
(c) decrypting, by the message viewing application, the encrypted message to a message in memory of the device, the message having a predetermined expiration time comprising a predetermined time from receipt of the message upon which the message is automatically deleted for viewing via the message viewing application;
(d) providing, by the message viewing application, the message from memory, for obscured viewing, only for the predetermined time between receipt of the message by the messaging view application and automatic deletion of the message by the message viewing application upon expiration of the predetermined expiration time for the message; and
(e) providing, by the message viewing application, an obscure viewer configured to be moved by a user over portions of the message at a time to display an unobscured view of only a portion of the message underlying a viewing area provided by the obscure viewer while portions of the message outside the viewing area provided by the obscure viewer remain obscured; and
(f) maintaining, by the message viewing application, remaining portions of the message obscured while the portion of the message underlying the viewing area corresponding to current placement of the obscure viewer is unobscured.

2. The method of claim 1, wherein step (a) further comprises receiving, by the server, a request from a second message viewing application, executing on a second device, to send the message to a user of the message viewing application, the server receiving the message from the second message viewing application securely and storing the message as the encrypted message on the server.

3. The method of claim 2, wherein step (a) further comprises receiving, by the server, the predetermined expiration time for the message specified from the second message viewing application.

4. The method of claim 1, wherein step (b) further comprises storing, by the message viewing application, the encrypted message to storage of the device.

5. The method of claim 4, wherein step (c) further comprises decrypting, by the message viewing application, the stored encrypted message and storing the message from the decryption only in the memory of the device.

6. The method of claim 1, wherein the predetermined time comprises one of a number of seconds or a number of minutes.

7. The method of claim 1, wherein step (d) further comprises receiving, by the message viewing application, a selection by a user to view the message within the message viewing application, the message viewing application displaying an amount of time remaining before the message is automatically deleted.

8. The method of claim 7, wherein step (d) further comprises displaying, by the message viewing application, the message as obscured.

9. The method of claim 1, wherein step (f) further comprises moving by a user of the message viewing application the obscure viewer over different portions of the obscures message those portions become unobscured with such movement while the once unobscured portions become obscured again.

10. The method of claim 1, wherein step (e) further comprises only allowing portions of the message to be viewed unobscured at a time during the predetermined time before the message is automatically deleted.

11. A system for providing a message for limited viewing, the system comprising:
a processor of a device;
a message viewing application executable on the processor of the device configured to receive a notification of an encrypted message stored on a server, retrieve the encrypted message from the server and decrypt the encrypted message to a message in memory of the device;
wherein the message has a predetermined expiration time comprising a predetermined time from receipt of the message by the messaging view application upon which the message is automatically deleted for viewing via the message viewing application; and
wherein the message viewing application is configured to provide the message from memory, for obscured viewing, only for the predetermined time between receipt of the message and automatic deletion of the message by the message viewing application upon expiration of the predetermined expiration time for the message,
wherein the message viewing application comprising an obscure viewer configured to be moved by a user over portions of the message at a time to display an unobscured view of only a portion of the message underlying a viewing area provided by the obscure viewer while portions of the message outside the viewing area provided by the obscure viewer remain obscured; and
wherein the message viewing application is configured to maintain remaining portions of the message obscured while the portion of the message underlying the viewing area corresponding to current placement of the obscure viewer is unobscured.

12. The system of claim 11, wherein the server is configured to receive a request from a second message viewing application, executable on a second device, to send the message to a user of the message viewing application, the server configured to receive the message from the second message viewing application securely and storing the message as the encrypted message on the server.

13. The system of claim 12, wherein the server is further configured to receive the predetermined expiration time for the message specified from the second message viewing application.

14. The system of claim 11, wherein the message viewing application is configured to store the encrypted message to storage of the device.

15. The system of claim 14, wherein the message viewing application is configured to decrypt the stored encrypted message and storing the message from the decryption only in the memory of the device.

16. The system of claim 11, wherein the predetermined time comprises one of a number of seconds or a number of minutes.

17. The system of claim 11, wherein the message viewing application is configured to receive a selection by a user to view the message within the message viewing application, the message viewing application displaying an amount of time remaining before the message is automatically deleted.

18. The system of claim 17, wherein the message viewing application is configured to display the message obscured.

19. The system of claim 11, wherein the message viewing application is configured to identify placement of the obscure viewer over the portion of the obscured message and to unobscure that portion while maintaining the remaining portions of the message obscured.

20. The system of claim 11, wherein the message viewing application is configured to only allow portions of the message to be viewed unobscured at a time during the predetermined time before the message is automatically deleted.
